(19) United States
(12) Patent Application Publication
(10) Pub. No.: US 2020/0063656 A1
(43) Pub. Date: Feb. 27, 2020

(54) INTERNAL COMBUSTION ENGINE WITH IOT CONNECTIVITY DEVICE

(71) Applicant: Honda Motor Co., Ltd., Tokyo (JP)

(72) Inventor: Andrew Bejcek, Chapel Hill, NC (US)

(21) Appl. No.: 16/113,653

(22) Filed: Aug. 27, 2018

(51) Int. Cl. F02B 77/08; F02B 63/04; A01D 34/68; H02K 7/18; H02K 7/02; H02K 11/35; H04L 29/08

(52) U.S. Cl. CPC F02B 77/083; F02B 63/042; A01D 34/68; A01D 2101/00; H02K 7/02; H02K 11/35; H04L 67/125; H02K 7/1815

(57) ABSTRACT

A power tool is provided. The power tool includes an internal combustion engine including a flywheel, a cover, and an Internet of Things (IoT) connectivity device. The cover is coupled to the internal combustion engine, and includes a recessed portion. The IoT connectivity device is coupled to the cover within the recessed portion, and receives power wirelessly from the flywheel only when the internal combustion engine is operating.

### BACKGROUND

This invention relates generally to Internet of Things (IoT) technology, and more particularly, to internal combustion engines that include IoT technology.

As the use of IoT technology is becoming more common for use in cooperation with power equipment, at least some known manufacturers have attempted to commercialize equipment using the technology. For example, at least some riding lawn mowers include a built-in meter in its instrument panel that includes Bluetooth wireless connectivity. Such meters transmit usage information to a remote device or to a cloud-based database. Although reliable, such IoT systems are generally only available on larger equipment as such systems require a battery and a charging system.

At least some other known riding mowers include a pass-through ignition switch connector. The ignition switch connector includes a main power circuit and a switched power circuit. The IoT device on such equipment uses the power circuit as a power source and uses the switched power circuit to determine whether the equipment is operating. Usage data is transmitted via Bluetooth wireless connectivity to a remote device or to a cloud-based database. Again, such IoT systems are generally only available on larger equipment as such systems require multiple power circuits, a battery, and a charging system.

In an effort to incorporate IoT technology on smaller equipment, at least some manufacturers include an IoT accessory that is coupled to the equipment, generally as a stick-on device, that acts as a Bluetooth-enabled hour meter. Specifically, such devices determine the engine is operating using an accelerometer to sense vibration. The information is transmitted to a remote device. Although, marketable, the use of such IoT accessories may be limited as the battery in such devices may require frequent replacement and/or the accelerometer may be prone to errors and/or accidental activation, such as when the mower is transported from one location to another.

### BRIEF DESCRIPTION

In one aspect, a power tool is provided. The power tool includes an internal combustion engine including a flywheel, a cover, and an Internet of Things (IoT) connectivity device. The cover is coupled to the internal combustion engine, and includes a recessed portion. The IoT connectivity device is coupled to the cover within the recessed portion, and receives power wirelessly from the flywheel only when the internal combustion engine is operating.

In another aspect, an engine assembly is provided. The engine assembly includes an internal combustion engine including a flywheel and a magnet, and an IoT connectivity device. The IoT connectivity device is configured to couple to the internal combustion engine, such that the IoT connectivity device receives power wirelessly from the flywheel magnet only when the internal combustion engine is operating.

In a further aspect, a power tool is provided. The lawnmower includes an internal combustion engine and an IoT connectivity device. The IoT connectivity device includes a power generation coil configured to harvest energy from the internal combustion engine only when the engine is operating, such that the IoT connectivity device receives power wirelessly from said internal combustion engine.

### BRIEF DESCRIPTION OF THE DRAWINGS

FIG. 1 is a perspective view of an exemplary walk-behind lawnmower.

FIG. 2 is a perspective view of an exemplary internal combustion engine assembly that may be used with the lawnmower shown in FIG. 1.

FIG. 3 is a partial cut-away plan view of the internal combustion engine assembly shown in FIG. 2.

### DETAILED DESCRIPTION

Embodiments of the present disclosure relate to power tools, including walk-behind lawnmowers, that include an internal combustion engine assembly including Internet of Things (IoT) technology. In some embodiments, the IoT technology is a device that is received in a recessed portion of a cover coupled to an internal combustion engine. In some embodiments the cover is fabricated from a magnetically non-permeable material, such as, but not limited to, a non-magnetic material such as plastic for example. In each implementation, the internal combustion engine includes a flywheel and a magnet coupled within a cavity defined by the cover. The IoT device includes a power generation coil that harvests energy from the flywheel magnet only when the engine is operating. The IoT device gathers usage data and transmits the data remotely without being coupled to a battery. The embodiments described herein are exemplary and are not limited to the descriptions provided. For example, although described in conjunction with a lawnmower, the invention described herein is not limited for use with a lawnmower, and may be instead used with other power tools or power equipment that includes an internal combustion engine, such as, but not limited to, snow blowers, leaf blowers, pressure washers, string trimmers, brush cutters, generators, chainsaws, water pumps, go-karts, plate compactors, tampers, powered augers, fans, and/or paint sprayers.

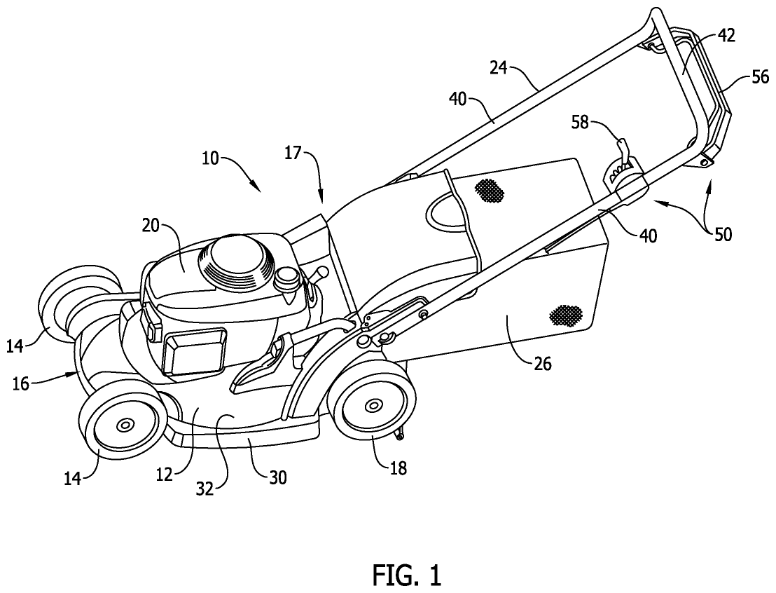

FIG. 1 is a perspective view of an exemplary walk-behind lawnmower 10. In the exemplary embodiment, lawnmower 10 is a self-propelled, walk-behind mower that is used to cut vegetation. In the exemplary embodiment, mower 10 includes a cutter housing or deck 12 that defines a cavity (not shown) below it. A pair of front wheels 14 are coupled to a forward side 16 of mower 10, and a second pair of rear wheels 18 are coupled to an opposite rear side 17 of mower 10. A cutting blade (not shown) is rotatably coupled to an internal combustion engine 20 such that the cutting blade is beneath deck 12. A steering handle 24 is coupled to deck 12 such that handle 24 extends upwardly from deck 12. In the exemplary embodiment, mower 10 includes an optional collection bag 26 removably coupled to mower rear side 17.

In the exemplary embodiment, deck 12 is generally rectangular includes a pair of opposing sides 30 that extend between forward and rear sides 16 and 17, respectively. In other embodiments, deck 12 may have any other shape that enables mower 10 to function as described herein. Deck 12 also includes an upper surface 32 and an opposite inner surface (not shown). The deck inner surface defines a portion of the cutter housing and defines a cavity (not shown) that the cutting blades are rotatably coupled within.

In the exemplary embodiment, the cutting blades are rotatably coupled to mower 10 and rotate about an axis of rotation (not shown) that is substantially vertical such that the blades rotate in generally horizontal cutting planes within the cutter housing cavity. The blades may be configured as either a single cutting element or as multiple cutting elements that each cut vegetation at the level of the cutting plane.

Handle 24 is generally U-shaped and extends upwardly and rearward from deck rear side 17. Handle 24 enables a user who walks behind mower 10 to guide and manipulate mower 10 during operation of mower 10. In the exemplary embodiment, handle 24 includes a pair of vertically-oriented support members 40 and a generally horizontally-oriented support member 42 that extends laterally between members 40 and that forms a hand grip for the user.

In the exemplary embodiment, handle 24 supports several controls 50 for the mower. For example, in the exemplary embodiment, mower 10 is self-propelled and includes a drive clutch lever 56 that is coupled to handle 24 to enable the user to selectively engage and disengage a transmission within the propulsion system. In addition, in the exemplary embodiment, a throttle lever 58 is coupled to handle 24. Throttle lever 58 enables a user to control and vary the engine speed. In addition, in the exemplary embodiment, mower 10 also includes a cutter system clutching system (not shown) that enables a user to selectively start and stop blade rotation. In one embodiment, the cutter system clutching system is similar to a known blade brake clutch (BBC) or a belt clutching pulley.

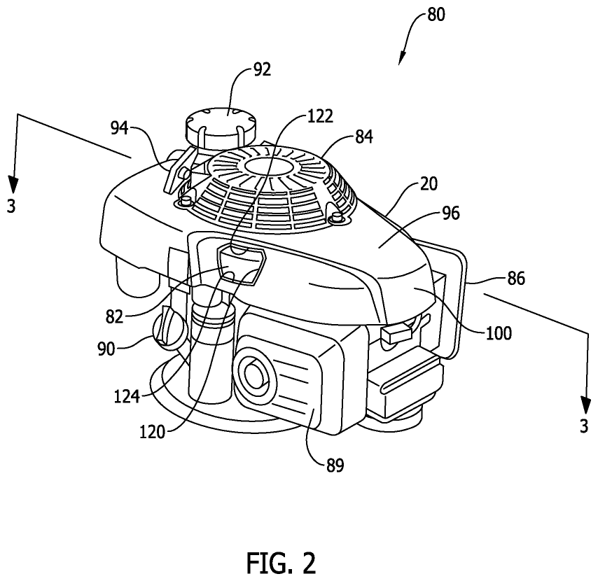

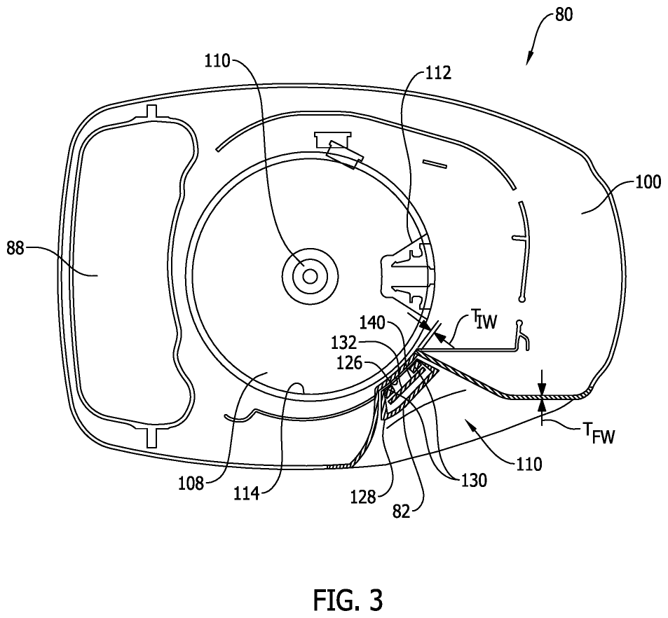

FIG. 2 is a perspective view of an exemplary internal combustion engine assembly 80 that may be used with lawnmower 10. FIG. 3 is a partial cut-away plan view of internal combustion engine assembly 80 shown in FIG. 2 shown in FIG. 2. Engine assembly 80 includes internal combustion engine 20 and an Internet of Things (IoT) connectivity device 82 coupled to engine 20 to monitor usage data of engine 20 as described in more detail below.

In the exemplary embodiment, engine 20 includes a fuel tank 88, an oil sump (not shown), a recoil starter assembly 84, an air cleaner assembly 86, and a muffler 89. An oil filler cap 90 provides access to the oil sump, and a fuel tank cap 92 provides access to fuel tank 88. Recoil starter assembly 84 includes a pull handle 94 and assembly 84 is coupled to engine 20 against an upper surface 96 of a cover 100. In one embodiment, engine 20 is similar to an engine used with an HRR216VLA Rotary Mower commercially available from American Honda Motor Co., Inc.

Recoil starter assembly handle 94 is connected to a starter rope (not shown) that enables a user to engage a starting mechanism (not shown) to start engine 20. In the exemplary embodiment, the starter rope is coupled to a pulley system that enables the rope to be pulled out and recoil automatically within assembly 84. More specifically, when the starter rope is pulled off the pulley and out of the engine, a recoil spring is stretched that recoils the rope onto the pulley when the user lets go of handle 94.

Pulling recoil starter assembly 84 causes a flywheel 108 to rotate with a crankshaft 111 within engine 20. Flywheel 108 is securely fixed to crankshaft 111 and includes at least one magnet 112 coupled to flywheel 108. More specifically, magnet 112 is coupled in close proximity to a radially outer edge 114 of flywheel 108 to enable magnetic energy to be formed as flywheel 108 is rotated. When enough magnetic energy is formed, an ignition module (not shown) ignites a voltage spark required for internal combustion within engine 20.

In the exemplary embodiment, cover 100 is fabricated from a magnetically non-permeable material, such as, but not limited to, a non-magnetic material such as plastic, and is formed with a recessed area 110. Recessed area 110 is sized to receive IoT connectivity device 82 therein. In one embodiment, IoT device 82 is removably coupled within area 110 in an interference fit. In another embodiment, IoT device is removably coupled within recessed area 110 using mechanical hardware, including for example, but not limited to, mechanical fasteners such as screws, snaps, anchor bolts, studs, or threaded fasteners, or hook and loop material. Alternatively, any other coupling means may be used, including removable adhesives or epoxy, that enables IoT device 82 to be removably coupled within recessed area 110. In other alternative embodiments, IoT device 82 may be permanently mounted within recessed area 110.

Recessed area 110, in the exemplary embodiment, is generally pentagon-shaped and is defined by a pair of side walls 120, an upper wall 122, a lower wall 124, and a radially inner wall 126. Alternatively, recessed area 110 may have any other shape that enables IoT device 82 and mower 10 to function as described herein. Moreover, in the exemplary embodiment, inner wall 126 is formed with a radius of curvature that substantially complements a portion of radially outer edge 114 of flywheel 108. Moreover, inner wall 126 is formed with a thickness T_{IW} that is thinner than a thickness T_{FW}. As such, the combination of the shape of inner wall 126 and the reduced thickness T_{IW} of wall 126 facilitates reducing an amount of clearance or space between IoT device 82 and flywheel 108. Accordingly, and as explained in more detail below, the orientation of IoT device 82 relative to flywheel 108 facilitates enhancing and maximizing the magnetic field strength from magnet 112 at IoT connectivity device 82.

As described above, in the exemplary embodiment, cover 100 is fabricated from a magnetically non-permeable material and is formed with a recessed area 110. In alternative embodiments, cover 100 may be made from a metallic material or other magnetically permeable material. In such embodiments, an opening (not shown) would be defined in wall 126 to enable IoT device 82 to function as described herein. In some of such embodiments, recessed area 110 may include a removable panel (not shown) that is used to cover the opening in wall 126 when IoT device 82 is not coupled therein. In some embodiments, recessed area 110 is stylized, such as with a dot with semi-circles radiating above it, to indicate that a wireless connectivity device may be coupled therein and that mower 10 is compatible with such a device.

In the exemplary embodiment, IoT device 82 includes a housing 128 that is shaped and sized to be removably coupled within recessed area 110. A power generation or power receiving coil 130, a power conditioning circuit 132, a microcontroller (not shown), and a wireless communications device (not shown), such as a Bluetooth module, are housed within housing 128. Power generation coil 130 harvests energy from flywheel magnet 112 during engine operations. More specifically, as flywheel 108 and magnet 112 are rotated during engine operation, a magnetic field is created. Moreover, rotation of flywheel 108 causes magnet 112 to rotate past coil 130, and the changing magnetic field induces a voltage in coil 130. More specifically, the relative location between power generation coil 130 and flywheel 108 facilitates IoT device 82 being subjected to the maximum available transient change in magnetic field for mower 10.

The voltage induced in coil 130 powers electronics coupled to a printed circuit board (PCB) 140 in connectivity device 82 without the use of a supplemental battery. Because of the flywheel construction, power is generated in bursts when magnet 112 passes device 82. Power conditioning circuit 132 facilitates rectifying the harvested energy and maintaining a useable voltage. Because device 82 is only powered when engine 20 is operating, no additional sensors are coupled to mower 10 to determine when engine 20 is operating. The microcontroller is known and is coupled to PCB 140 to measure, store, and/or maintain a log of usage-based data, including a log of operating hours. Moreover, the microcontroller stores the usage data in non-volatile memory periodically, or when engine 20 is being shut down. The wireless communications device is known, and transmits or broadcasts usage data to a remote receiver.

During operation, usage-based data is transmitted from mower 10 to a remote receiver, such as a smart phone, or to a cloud-based storage. The combination of the construction of cover 100 and the relative proximity of components on mower 10, enables IoT connectivity device 82 to operate, be energized, and gather usage data without a supplemental battery being coupled IoT device 82. Moreover, because IoT device 82 only operates when engine 20 is operating, no additional sensors, including accelerometers, are necessary to determine operation of engine 20.

The above-described mower uses an internal combustion engine coupled to an IoT connectivity device that is cost-effective to manufacture and assemble, and that facilitates reducing the number of components, and the complexity of components necessary to monitor usage data associated with the internal combustion engine. The IoT connectivity device described herein could be flexible and adaptable for use with equipment other than lawn mowers that includes an internal combustion engine.

Exemplary embodiments of power tools, and more specifically, mower architecture are described above in detail. Although the mower architecture are herein described and illustrated in association with a walk-behind lawnmower, the invention is also intended for use on commercial walk-behind mowers. Moreover, it should also be noted that the components of the invention are not limited to the specific embodiments described herein, but rather, aspects of each component may be utilized independently and separately from other components and methods of assembly described herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A power tool comprising:
an internal combustion engine comprising a flywheel;
a cover coupled to said internal combustion engine, said cover comprising a recessed portion; and
an Internet of Things (IoT) connectivity device coupled to said cover within said recessed portion, said IoT connectivity device receives power wirelessly from said flywheel only when said internal combustion engine is operating.

2. A power tool in accordance with claim 1 wherein said IoT connectivity device comprises a power generation coil configured to harvest energy from said flywheel.

3. A power tool in accordance with claim 2 wherein said IoT device is not primarily powered by a battery.

4. A power tool in accordance with claim 1 wherein at least a portion of said cover defining said recessed portion is fabricated from a magnetically non-permeable material.

5. A power tool in accordance with claim 1 wherein a thickness of said cover is thinner within said recessed portion than in remaining portions of said cover.

6. A power tool in accordance with claim 1 wherein said flywheel is rotatably coupled within a cavity defined within said cover, said recessed portion includes an opening coupling within said recessed portion in communication with said cover cavity.

7. A power tool in accordance with claim 1 wherein said IoT device comprises at least one of:
a microcontroller for at least one of measuring operating time, storing operating time, and maintaining a log of operating hours; and
a wireless communications device for broadcasting usage-based data from said microcontroller.

8. An engine assembly comprising:
an internal combustion engine comprising a flywheel, said flywheel comprises a magnet; and
an Internet of Things (IoT) connectivity device configured to couple to said internal combustion engine, said IoT connectivity device receives power wirelessly from said flywheel magnet only when said internal combustion engine is operating.

9. An engine assembly in accordance with claim 8 wherein said IoT connectivity device comprises:
a power generation coil configured to harvest energy from the movement of said flywheel magnet; and
a power conditioning circuit configured to maintain a useable voltage for said IoT connectivity device.

10. An engine assembly in accordance with claim 8 further comprising a cover, said flywheel rotatably coupled within a cavity defined by said cover, said cover comprises a recessed portion.

11. An engine assembly in accordance with claim 10 wherein at least a portion of said cover defining said recessed portion is fabricated from a magnetically non-permeable material.

12. An engine assembly in accordance with claim 10 wherein a thickness of said cover is thinner within said recessed portion than in remaining portions of said cover.

13. An engine assembly in accordance with claim 10 wherein said IoT device is coupled within said recessed portion.

14. An engine assembly in accordance with claim 10 wherein said recessed portion comprises an opening defined therein coupling said cover cavity with said IoT device.

15. An engine assembly in accordance with claim 8 wherein said IoT device is not primarily powered by a battery.

16. An engine assembly in accordance with claim 8 wherein said engine assembly is used with one of a lawn mower, a snow blower, a leaf blower, a tiller, a pressure washer, a string trimmer, a brush cutter, a generator, a chainsaw, a water pump, a go-kart, a plate compactor, a tamper, a powered auger, a fan, and a paint sprayer.

17. An engine assembly in accordance with claim 8 wherein said IoT device transmits usage-based data to a remote receiver.

18. A power tool comprising:
an internal combustion engine; and
an Internet of Things (IoT) connectivity device comprising a power generation coil configured to harvest energy from said internal combustion engine only when said engine is operating, wherein said IoT connectivity device receives power wirelessly from said internal combustion engine.

19. A power tool in accordance with claim 18 wherein said internal combustion engine comprises a flywheel and a magnet, said flywheel rotates past said magnet, said IoT device is coupled to said engine in close proximity to said magnet to enable said power generation coil to harvest energy without being coupled to a battery.

20. A power tool in accordance with claim 19 wherein said IoT device is coupled within a recess formed on said engine, said IoT device further comprises a printed circuit board coupled to a microcontroller for maintaining a log of operating hours, and to a wireless communications device for broadcasting usage-based data from said microcontroller.
